(19) United States
(12) Patent Application Publication
(10) Pub. No.: US 2024/0135025 A1
(43) Pub. Date: Apr. 25, 2024

(54) QUERY PROCESSING METHOD AND APPARATUS

(71) Applicant: Alipay (Hangzhou) Information Technology Co., Ltd., Hangzhou (CN)

(72) Inventors: Jian DU, Hangzhou (CN); Benyu ZHANG, Hangzhou (CN)

(21) Appl. No.: 18/395,080

(22) Filed: Dec. 22, 2023

Related U.S. Application Data
(63) Continuation of application No. PCT/CN2022/105053, filed on Dec. 7, 2022.

(30) Foreign Application Priority Data
Sep. 23, 2021 (CN) 202111110468.2

(51) Int. Cl. G06F 21/62

(52) U.S. Cl. CPC G06F 21/6227

(57) ABSTRACT

Implementations of the present specification provide a query processing method and apparatus. The method includes: first, determining query types of L queries to be performed on a target dataset, where the target dataset includes data of an object; next, determining query sensitivity of each query type of the query types for the target dataset; and then, determining, based on the query sensitivity corresponding to each query and a privacy budget parameter predetermined for a total set of the L queries, a noise power allocated to each query. Based on this, for a target query in the L queries, an actually returned result of the target query can be determined as an original query result of the target query added with a target noise sampled from target noise distribution of differential privacy, where the target noise distribution is determined based on the noise power allocated to the target query. As such, privacy of the target dataset can be protected.

### TECHNICAL FIELD

One or more implementations of the present specification relate to the field of data processing technologies, and in particular, to a query processing method and apparatus.

### BACKGROUND

With the advent of the big data era, how to mine data values has become a current research hotspot. In a mining manner, statistical processing is performed on a large amount of data to provide a statistical query service to the outside. However, there is a risk of leakage of a single data record in the query service. For example, if somebody finds that a mean of the first 500 lines of data is 20, and finds that a mean of the first 501 lines of data is 20.1, she can learn that a value of a 501^{st} line of data is 70.1.

The differential privacy (DP) technology is used in a statistical query scenario to address the privacy leakage problem. A difficulty in this technology lies in how to balance privacy security of data and accuracy of a query result, because improvement of the former usually leads to reduction of the latter.

### SUMMARY

The specification is directed to an improved differential privacy solution, which reduces a risk of privacy leakage of sensitive data while improving accuracy of a query result.

One or more implementations of the present specification describe a query processing method and apparatus, to allocate, to each query in a batch of queries, a suitable noise power that balances data privacy protection and accuracy of a query result.

According to an aspect, a query processing method for data privacy protection is provided, including: determining query types of L queries to be performed on a target dataset, where the target dataset includes data of an object; determining query sensitivity of each query type of the query types for the target dataset; and determining, based on the query sensitivity corresponding to each query and a privacy budget parameter predetermined for a total set of the L queries, a noise power allocated to each query.

In an implementation, the determining the query types of the L queries to be performed on the target dataset includes: receiving L query requests for the target dataset, where each query request indicates a query type of the query request.

In an implementation, the determining the query types of the L queries to be performed on the target dataset includes: obtaining a number L of queries that can be performed that is preconfigured for the target dataset and a query type of each of the queries.

In an implementation, the query type is any one of following: a counting query, a maximum value query, a minimum value query, a mean value query, or a variance query.

In an implementation, the object is any one of following: a user, a commodity, or a business event.

In an implementation, the business event is any one of following: registration, access, login, or payment.

In an implementation, the object is a user, and the data of the business event is any one of following: age, gender, income, interests and hobbies, physiological indicators, or operation indicators.

In an implementation, the determining the query sensitivity of each query type of the query types for the target dataset includes: for each query type of the query types, obtaining the query sensitivity corresponding to the query type based on a greatest absolute difference between a first result and a second result, where the first result is a result obtained by performing the type of query on the target dataset, and the second result is a result obtained by performing the type of query on an adjacent dataset of the target dataset.

In an implementation, the query types include a counting query, and the determining the query sensitivity of each query type of the query types for the target dataset includes: determining the query sensitivity of the counting query to be a value of 1.

In an implementation, the query types include a maximum value query or a minimum value query, and the determining the query sensitivity of each query type of the query types for the target dataset includes: determining a greatest value and a smallest value in the target dataset; and determining a result of subtracting the smallest value from the greatest value as the query sensitivity of the maximum value query or the minimum value query.

In an implementation, the query types include a mean value query, and the determining the query sensitivity of each query type of the query types for the target dataset includes: determining a greatest value in the target dataset; and determining a ratio between an absolute value of the greatest value and an amount of data in the target dataset plus 1 as the query sensitivity of the mean value query.

In an implementation, the query types include a variance query, and the determining the query sensitivity of each query type of the query types for the target dataset includes: determining a greatest value and a smallest value in the target dataset; and determining a product of following factors as the query sensitivity of the variance query: a square of a difference between the greatest value and the smallest value, an amount of data in the target dataset, and a reciprocal of a result obtained after a square operation is performed on the amount of data plus 1.

In an implementation, the determining, based on the query sensitivity corresponding to each query and the privacy budget parameter predetermined for the total set of the L queries, the noise power allocated to each query includes: determining a sum of the query sensitivity of the L queries based on the query sensitivity of each query; and for any query, determining, based on the query sensitivity of the query, the sum of the query sensitivity, and the privacy budget parameter, the noise power allocated to the query.

In an implementation, the determining, based on the query sensitivity of the query, the sum of the query sensitivity, and the privacy budget parameter, the noise power allocated to the query includes: obtaining a variable value of a mean variable, where the variable value is determined based on a parameter value of the privacy budget parameter and a constraint relationship between the privacy budget parameter and the mean variable in a Gaussian mechanism of differential privacy; and determining a product of following factors as the noise power of the query: the query sensitivity of the query, the sum of the query sensitivity, and a reciprocal of a result obtained after a square operation is performed on the variable value.

In an implementation, the privacy budget parameter includes a budget parameter and a relaxation parameter.

In an implementation, after the determining the noise power allocated to each query, the method further includes: for a target query in the L queries, determining an actually returned result of the target query as an original query result of the target query added with a target noise sampled from target noise distribution of differential privacy, where the target noise distribution is determined based on the noise power allocated to the target query.

In an implementation, the target noise distribution is Gaussian noise distribution, and the Gaussian noise distribution uses the noise power of the target query as a variance and uses 0 as a mean.

In an implementation, the method further includes: receiving a current query request for the target dataset, where the current query request corresponds to a current query type; determining whether a number of processed requests corresponding to the current query type is less than a predetermined threshold, where query requests corresponding to the number of processed requests are directed to the target dataset; and using the current query request as the target query in response to determining that the number of processed requests is less than the predetermined threshold.

According to an aspect, a query processing apparatus for data privacy protection is provided, including: a query type determining unit, configured to determine query types of L queries to be performed on a target dataset, where the target dataset includes data of an object; a sensitivity determining unit, configured to determine query sensitivity of each query type of the query types for the target dataset; and a noise power determining unit, configured to determine, based on the query sensitivity corresponding to each query and a privacy budget parameter predetermined for a total set of the L queries, a noise power allocated to each query.

In an implementation, the query type determining unit is configured to receive L query requests for the target dataset, where each query request indicates a query type of the query request.

In an implementation, the query type determining unit is configured to obtain a number L of queries that can be performed that is preconfigured for the target dataset and a query type of each of the queries.

In an implementation, the object is any one of following: a user, a commodity, or a business event.

In an implementation, the sensitivity determining unit is configured to: for each query type of the query types, obtain the query sensitivity corresponding to the query type based on a greatest absolute difference between a first result and a second result, where the first result is a result obtained by performing the type of query on the target dataset, and the second result is a result obtained by performing the type of query on an adjacent dataset of the target dataset.

In an implementation, the apparatus further includes an actual result determining unit, configured to: for a target query in the L queries, determine an actually returned result of the target query as an original query result of the target query added with a target noise sampled from target noise distribution of differential privacy, where the target noise distribution is determined based on the noise power allocated to the target query.

In an implementation, the apparatus further includes a target query determining unit, configured to: receive a current query request for the target dataset, where the current query request corresponds to a current query type; determine whether a number of processed requests corresponding to the current query type is less than a predetermined threshold, where query requests corresponding to the number of processed requests are directed to the target dataset; and use the current query request as the target query in response to determining that the number of processed requests is less than the predetermined threshold.

According to an aspect, a computer-readable storage medium is provided. The computer-readable storage medium stores a computer program, and when the computer program is executed in a computer, the computer is enabled to perform the method provided in the first aspect.

According to an aspect, a computing device is provided, including a memory and a processor. The memory stores executable code, and when executing the executable code, the processor implements the method provided in the first aspect.

The method and the apparatus provided in the implementations of the present specification, and the query processing method for data privacy protection disclosed in the implementations of the present specification can be used to allocate, to each query in a batch of queries, a lowest noise power prevents data privacy from being leaked to maximize accuracy of a query result.

### BRIEF DESCRIPTION OF DRAWINGS

To describe the technical solutions in the implementations of the present invention more clearly, the following is a brief introduction of the accompanying drawings for illustrating such technical solutions. Clearly, the accompanying drawings described below are merely some implementations of the present invention, and a person of ordinary skill in the art can still derive other drawings from such accompanying drawings without making innovative efforts.

FIG. 1 is a schematic diagram illustrating an implementation architecture of a query processing solution according to an implementation;

FIG. 2 is a schematic flowchart illustrating a query processing method according to an implementation;

FIG. 3 is a schematic diagram illustrating an implementation architecture of a query processing solution according to an implementation;

FIG. 4 is a schematic diagram illustrating an implementation architecture of a query processing solution according to still an implementation;

FIG. 5 is a schematic diagram illustrating an implementation architecture of a query processing solution according to yet an implementation; and

FIG. 6 is a schematic diagram illustrating a structure of a query processing apparatus according to an implementation.

### DESCRIPTION OF EMBODIMENTS

The following describes the solutions provided in the present specification with reference to the accompanying drawings.

As described herein, the differential privacy (DP) technology may be used in a statistical query scenario, which addresses the privacy leakage problem. Generally, random noise is added to an original query result to prevent an actually returned query result from leaking original private data. However, it is difficult for existing solutions to achieve a balance between data security and accuracy of a returned result.

Based on this, implementations of the present specification disclose a query processing solution implemented based on differential privacy. An suitable noise power can be allocated to each query (or referred to as each time of query) in a batch of queries, so that even if an attacker obtains returned results of the batch of queries, the attacker cannot decipher the queried original data, and accuracy and availability of a returned result of each query are improved.

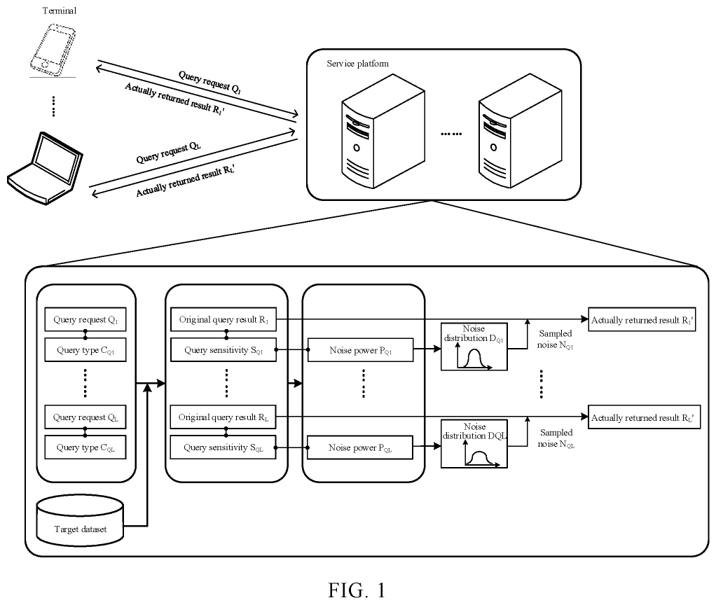

FIG. 1 is a schematic diagram illustrating an implementation architecture of a query processing solution according to an implementation. As shown in FIG. 1, a service platform provides a query service. First, the service platform receives L query requests from a terminal, where FIG. 1 shows a first query request Q₁ and an L^{th} query request Q_{L}. Then, the service platform determines, based on a query type of each of the L query requests, query sensitivity of each query request for a target dataset. Afterwards, the service platform determines, based on the query sensitivity corresponding to each query request and a total number of privacy budget parameters predetermined for the L queries, a noise power allocated to each query request, where FIG. 1 shows a noise power P_{Q1} and a noise power P_{QL} allocated to query request Q₁ and query request Q_{L}. Next, for a target query request (e.g., query request Q₁) in the L query requests, the service platform determines target noise distribution (e.g., noise distribution D_{Q1}) of differential privacy based on the noise power (e.g., a noise power P_{Q1}) allocated to the target query request, samples a target noise (e.g., a noise N_{Q1}) from the target noise distribution, and adds the target noise to an original query result (e.g., an original query result R₁) of the target query to obtain an updated result as an actually returned result (e.g., an actually returned result R1′) of the target query.

Example implementation steps of the example query processing solution are described below with reference to example implementations.

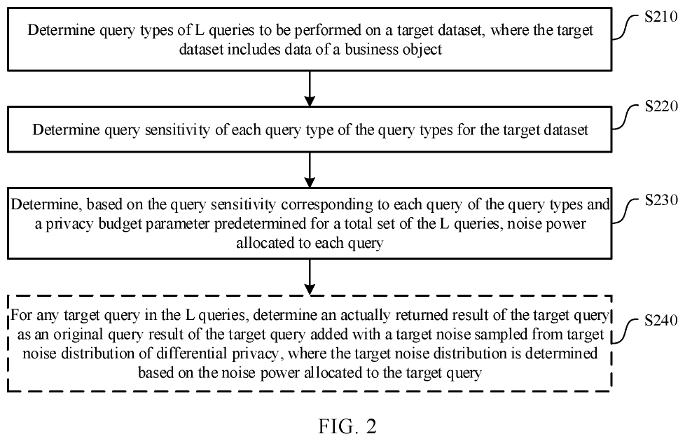

FIG. 2 is a schematic flowchart illustrating a query processing method according to an implementation. The method can be performed by any server, apparatus, platform, or device cluster that has a computing and processing capability, for example, can be performed by the service platform shown in FIG. 1 or a user terminal. As shown in FIG. 2, the method includes the following steps.

Step S210: Determine query types of L queries to be performed on a target dataset, where the target dataset includes data of an object. Step S220: Determine query sensitivity of each query type of the query types for the target dataset. Step S230: Determine, based on the query sensitivity corresponding to each query and a privacy budget parameter predetermined for a total set of the L queries, a noise power allocated to each query.

The above steps are described in detail as follows.

First, in step S210, query types of L queries to be performed on a target dataset are determined. The target dataset includes a plurality of data records (or referred to as a plurality of data samples) corresponding to data of (or referred to as private data) of objects. It should be noted that, objects corresponding to any two data records may be the same (e.g., corresponding to the same user), or may be different (e.g., corresponding to different commodities), and the plurality of data records correspond to the same feature of the object (e.g., the age of a user). In addition, a storage environment of the plurality of data records is not limited. In a possible storage case, the plurality of data records are stored in a database. For example, a service platform pre-collects personal information authorized by a user, and stores the personal information in the database. In an possible storage case, the plurality of data records are stored in a user terminal. For example, the user terminal (e.g., a smartphone) collects terminal operation data of a user (behavior data of inputting emoticons), and stores the terminal operation data.

In an implementation, the object can be a user. In an example implementation, the object can be an individual user. Correspondingly, the plurality of data samples correspond to features of the individual user, such as the individual user's name, age, gender, income, identity card number, mobile phone number, email address, interests and hobbies, physiological indicators, or operation indicators. In an example, the physiological indicator is used to measure a human health condition, and can be, for example, blood pressure, blood lipids, cholesterol, or blood oxygen concentration. In an example, the operation indicator corresponds to identified operation behavior, such as payment, click, or browsing, and is used to measure duration or a frequency of performing the specific operation behavior by the user. In an example implementation, the object can be an enterprise user. Correspondingly, the plurality of data samples correspond to features of the enterprise user, such as the enterprise use's tax data, suppliers, flow funds on the book, or annual revenue.

In an implementation, the object can be a commodity. For example, the commodity can be a physical commodity, such as a garage kit or a paper book; can be an empirical service, such as a tourism product, a massage service, a video membership service, a network course, or a payment membership service; or can be a virtual product, such as a game skin, an e-book, content information, a video resource, cloud disk space, or traffic. Correspondingly, the plurality of data samples correspond to features of the commodity, such as costs, an inventory, a sales volume, or a gross profit of the commodity.

In still an implementation, the object can be a business event, such as a registration event, an access event, a login event, or a payment event. Correspondingly, the plurality of data samples correspond to event features, such as an occurrence moment, a network environment, a geographical location, or duration of the business event. In an example, the network environment can be an IP address, a network type, etc. It should be understood that the network type can include Wi-Fi, a 4G network, a 5G network, etc.

The target dataset is described herein by using the examples in which the object is a user, a commodity, and a business event. It should be understood that the object is not limited to these example types. The example query for the target dataset is a statistical query, which is used to query statistical information or aggregation information of the target dataset. For example, if the target dataset includes a plurality of user names, a number of users whose last name is Huang can be queried.

For the L queries and the query types of the queries, it should be noted that, L is a positive integer, and can have a value of 1, but is usually greater than 1. When L>1, query types corresponding to any two queries may be the same or different. For example, several (i.e., one or more) query types related to the L queries can include a counting query, a maximum value query (or “maximum query”), a minimum value query (or “minimum query”), a mean value query (or “mean query”), and a variance query. In addition, in an implementation scenario, the L queries correspond to query information preconfigured for future query requests, including a number L of queries that can be performed and a query type of each of the queries. In an implementation scenario, the L queries depend on received L query requests, where each query request indicates a query type of the query request. For detailed descriptions of the two implementation scenarios, references can be made to the following descriptions.

According to the descriptions herein, the query types of the L queries can be determined. Next, in step S220, query sensitivity of each of the several query types related to the L queries for the target dataset is determined.

It should be noted that, query sensitivity of a certain type is intended to reflect a greatest difference between a first result obtained by performing the type of query based on the target dataset and a second result obtained by performing the type of query based on an adjacent dataset of the target dataset. The adjacent dataset is a dataset that can be obtained after any piece of data is added to or deleted from the target dataset. A measurement criterion of the greatest difference measurement can be set based on an actual requirement, for example, the measurement criterion is quantized as a greatest value of an absolute value of a difference (or referred to as a greatest absolute difference in the present specification) between the first query result and the second query result. However, actually, not all greatest differences such as greatest absolute differences corresponding to all query types can be precisely solved. In this case, an approximate value or an estimated value of the greatest difference can be solved and used as the query sensitivity.

Calculation of the query sensitivity is described below with reference to specific examples of the query type.

According to an implementation, the several query types include a counting query. For the counting query, it should be noted that the plurality of data samples in the target dataset correspond to features of an object, and value space of the feature includes a plurality of possible values, for example, possible values of a user gender include “male” and “female”. Correspondingly, the plurality of values can be used as a plurality of data categories, so that the counting query can be performed on a certain data category, that is, a number of data samples corresponding to the data category is queried. For example, a number of female users in a user dataset is queried.

It can be learned from the description herein of the counting query that, when the counting query is performed on a certain data category, because a difference between a number of pieces of data in the target dataset and a number of pieces of data in an adjacent dataset of the target dataset is 1, and the difference of the piece of data either belongs to the data category or does not belong to the data category, an absolute value of a difference between two query results is either 1 or 0. Therefore, 1 can be determined as the query sensitivity of the counting query, which can be denoted as:

sens_{c}=1 (1)

As such, the query sensitivity sens e corresponding to the counting query can be determined.

According to an implementation, the several query types include a maximum value query. For clear description, the target dataset is denoted as x=(x₁, . . . , x_{N}) in the present specification, where N represents a total number of data samples, and xᵢ represents an i^{th} data sample. In addition, a result of soring the N data samples in ascending order is denoted as x₍₁₎≤x₍₂₎≤. . . ≤x_{(N)}. It can be understood that x₍₁₎ and x_{(N)} respectively represent a smallest value (“minimum value”) and a greatest value (“maximum value”) in the N data samples. Value space of a feature corresponding to the target dataset has a natural upper value bound and a lower value bound, or an employee can set the upper value bound and the lower value bound for the feature. The upper value bound and the lower value bound can be respectively denoted as l and u, and therefore l≤x₍₁₎≤x₍₂₎≤. . . ≤x_{(N)}≤u can be obtained.

Based on the definition of the maximum value query type and the query sensitivity, in an example, the query sensitivity corresponding to the maximum value query can be determined as:

sensₘₐₓ=u−l (2)

In an example, the query sensitivity corresponding to the maximum value query can be determined as:

sensₘₐₓ=x_{(N)}−x₍1) (3)

As such, the query sensitivity sens max corresponding to the maximum value query can be determined.

According to still an implementation, the several query types include a minimum value query. Similar to the determining the query sensitivity sens max corresponding to the maximum value query, in an example, the query sensitivity corresponding to the minimum value query can be determined as:

sensₘᵢₙ=u−l (4)

In an example, the query sensitivity corresponding to the minimum value query can be determined as:

sensₘᵢₙ=x_{(N)}−x₍₁₎ (5)

As such, the query sensitivity sensₘᵢₙ corresponding to the minimum value query can be determined.

According to yet an implementation, the several query types include a mean value query. Mean calculation for the target dataset can be denoted as:

$${x}_{mean} := f ( x ) = \frac{{\sum }_{i = 1}^{N} {x}_{i}}{N} \qquad ( 6 )$$

It is assumed that data y is added to the adjacent dataset x′ compared with the target dataset x, and x₍₁₎≤y≤x_{(N)}, that is, x′=(x₁, . . . , x_{N}, y). Therefore, in an example, the query sensitivity corresponding to the mean value query can be calculated by using the following equation:

$$\begin{matrix}\vert f ( {x}^{′} ) - f ( x ) \vert = \vert \frac{{\sum }_{i = 1}^{N} {x}_{i} + y}{N + 1} - \frac{{\sum }_{i = 1}^{N} {x}_{i}}{N} \vert \leq \\ \vert \frac{{\sum }_{i = 1}^{N} {x}_{i} + y}{N + 1} - \frac{{\sum }_{i = 1}^{N} {x}_{i}}{N + 1} \vert \\ = \vert \frac{{\sum }_{i = 1}^{N} {x}_{i} + y - {\sum }_{i = 1}^{N} {x}_{i}}{N + 1} \vert \leq \\ \frac{\vert {x}_{( N )} \vert}{N + 1}\end{matrix} \qquad ( 7 )$$

Therefore, the query sensitivity corresponding to the mean value query can be denoted as:

$$s e n {s}_{m e a n} = \frac{\vert {x}_{( N )} \vert}{N + 1} \qquad ( 8 )$$

As such, the query sensitivity sensₘₑₐₙ corresponding to the mean value query can be determined.

According to an implementation, the several query types include a variance query. A mean of the data samples in the target dataset x is denoted as μ, and therefore variance calculation for the target dataset x can be denoted as:

$$\begin{matrix}{x}_{var} := f ( x ) = \frac{1}{N} {\sum }_{i = 1}^{N} {( {x}_{i} - μ )}^{2} \\ = \frac{1}{2 {N}^{2}} {\sum }_{i = 1}^{N} {\sum }_{j = 1}^{N} {( {x}_{i} - {x}_{j} )}^{2}\end{matrix} \qquad ( 9 )$$

It is assumed that data y is added to the adjacent dataset x′ compared with the target dataset x, and x₍₁₎≤y≤x_{(N)}, that is, x′=(x₁, . . . , x_{N}, y). Therefore, the query sensitivity corresponding to the variance query can be calculated by using the following equation:

$$\begin{matrix}\vert f ( {x}^{′} ) - f ( x ) \vert = \vert \frac{{\sum }_{i = 1}^{N + 1} {\sum }_{j = 1}^{N + 1} {( {x}_{i} - {x}_{j} )}^{2}}{2 {( N + 1 )}^{2}} - \frac{{\sum }_{i = 1}^{N + 1} {\sum }_{j = 1}^{N + 1} {( {x}_{i} - {x}_{j} )}^{2}}{2 {N}^{2}} \vert \\ \leq \vert \frac{{\sum }_{i = 1}^{N + 1} {\sum }_{j = 1}^{N + 1} {( {x}_{i} - {x}_{j} )}^{2}}{2 {( N + 1 )}^{2}} - \frac{{\sum }_{i = 1}^{N + 1} {\sum }_{j = 1}^{N + 1} {( {x}_{i} - {x}_{j} )}^{2}}{2 {( N + 1 )}^{2}} \vert \\ = \vert \frac{2 {\sum }_{i = 1}^{N + 1} {( {x}_{i} - y )}^{2}}{2 {( N + 1 )}^{2}} \vert \\ \leq \frac{{N ( {x}_{( N )} - {x}_{( 1 )} )}^{2}}{{( N + 1 )}^{2}}\end{matrix} \qquad ( 10 )$$

Therefore, the query sensitivity corresponding to the variance query can be denoted as:

$${sens}_{var} = \frac{N}{{( N + 1 )}^{2}} {( {x}_{( N )} - {x}_{( 1 )} )}^{2} \qquad ( 11 )$$

As such, the query sensitivity sens var corresponding to the variance query can be determined.

Calculation of the query sensitivity is described herein by using the examples in which the query type is the counting query, the maximum value query, the minimum value query, the mean value query, and the variance query. Actually, query types related to the L queries are not limited to these several example types, and can further include other types, such as a quantile query and a weight of evidence query. Query sensitivity corresponding to the other query types can be calculated with reference to the definition of the two queries, and exhaustive listing is not performed herein.

According to the descriptions herein, the query sensitivity corresponding to each query type of the query types related to the L queries can be determined. It should be understood that each query has a corresponding query type, and each query type of the query types has corresponding query sensitivity. Therefore, the query sensitivity corresponding to each query can be obtained.

Then, in step S230, a noise power allocated to each query is determined based on the query sensitivity corresponding to each query and the privacy budget parameter predetermined for the total set of the L queries.

In an implementation, this step can include following: For any [symbol] ^{th} query in the L queries, the noise power allocated to the query is determined based on query sensitivity sense of the query, a sum of the query sensitivity of the L queries, and the privacy budget parameter. It should be noted that the sum of the query sensitivity is obtained by performing summation based on the query sensitivity of each of the L queries.

In an example implementation, a variable value of a mean variable μ is first determined based on a parameter value of the privacy budget parameter and a constraint relationship between the privacy budget parameter and the mean variable in a Gaussian mechanism of differential privacy. The constraint relationship is existing in the Gaussian mechanism of differential privacy, and can be expressed by the following equation:

$$δ ( ε : μ ) = Φ ( - \frac{ε}{μ} + \frac{μ}{2} ) - {e}^{ε} Φ ( - \frac{ε}{μ} - \frac{μ}{2} ) \qquad ( 12 )$$

In the equation (12), ε and δ respectively represent a budget parameter and a relaxation parameter in the privacy budget parameter, and parameter values of the two parameters can be manually set by an employee based on an actual requirement; μ represents the mean variable; and Φ(t) represents a probability distribution function of standard Gaussian distribution, where

$$Φ ( t ) = ℙ [ 𝒩 ( 0 , 1 ) \leq t ] = \frac{1}{\sqrt{2 π}} {\int }_{- ∞}^{t} {e}^{- {y}^{2} / 2} dy .$$

Further, for any [symbol] query, a product of following factors is determined as the noise power of the query: the query sensitivity sen [symbol] , the sum of the query sensitivity, and a reciprocal of a result obtained after a square operation is performed on the variable value of the mean variable. Therefore, an equation for calculating the noise power can be expressed as:

$$\begin{matrix}{σ}_{ℓ , opt}^{2} = \frac{{sens}_{ℓ}}{{μ}^{2}} ( {\sum }_{k = 1}^{L} {sens}_{k} ) , & ℓ = 1 , … , L\end{matrix} \qquad ( 13 )$$

In the equation (13), [symbol] represents the noise power of the [symbol] ^{th} query, sen [symbol] represents the query sensitivity of the [symbol] ^{th} query, μ represents the mean variable, and

$${\sum }_{k = 1}^{L} s e n {s}_{k}$$

represents the sum of the query sensitivity of the L queries.

It should be noted that a derivation process of equation (13) is as follows.

A total noise power of the L queries is minimized under a privacy constraint, which is equivalent to the following optimization problem:

$$Constraint function : {\sum }_{k = 1}^{L} \frac{{S}_{k}^{2}}{{σ}_{k}^{2}} \leq {μ}^{2}$$

Original function that needs to be solved:

$${minimize}_{{\{ {σ}_{k}^{2} > 0 \}}_{k = 1}^{L}} \qquad ( 14 )$$

$${\sum }_{k = 1}^{L} {σ}_{k}^{2} \qquad ( 15 )$$

In equations (14) and (15), Sₖ represents the query sensitivity of the k^{th} query, μ represents the mean variable, and σₖ² represents the noise power of the k^{th} query.

It should be noted that the optimization problem is a convex optimization problem and satisfies the Slater's condition, and therefore has strong duality. For this optimization problem, a Lagrange multiplier λ is introduced, and the following Lagrange [symbol] is constructed, to associate the constraint function with the original function:

$$ℒ ( {\{ {σ}_{k}^{2} \}}_{k = 1}^{L} , λ ) = {\sum }_{k = 1}^{L} {σ}_{k}^{2} + λ ( {\sum }_{k = 1}^{L} \frac{{S}_{k}^{2}}{{σ}_{k}^{2}} - {μ}^{2} ) \qquad ( 16 )$$

A feasible solution σₖ² of equation (16) needs to satisfy the Karush-Kuhn-Tucker (KKT) condition:

$$\{ \begin{matrix}\begin{matrix}\frac{\partial ℒ}{\partial {σ}_{ℓ}^{2}} = 1 - λ \frac{{S}_{ℓ}^{2}}{{σ}_{ℓ}^{4}} , & ℓ = 1 , … L\end{matrix} \\ λ ( {\sum }_{k = 1}^{L} \frac{{S}_{k}^{2}}{{σ}_{k}^{2}} - {μ}^{2} ) = 0\end{matrix} \qquad ( 17 )$$

Therefore, if Lagrange [symbol] is minimized when the KKT condition is satisfied, the following optimal noise power allocation policy can be obtained:

$${σ}_{ℓ , opt}^{2} = \frac{{S}_{ℓ}}{{μ}^{2}} ( {\sum }_{k = 1}^{L} {S}_{k} ) \qquad ( 18 )$$

It should be understood that equation (18) is equivalent to equation (13), except that the notation of mathematical symbols is slightly different.

According to the descriptions herein, the noise power allocated to each query in the Gaussian noise mechanism of differential privacy can be determined. It should be noted that, actually, the noise power of each query in other noise mechanisms, such as a Laplace mechanism and an exponential mechanism, can also be determined.

According to an implementation of an aspect, after step S230, the method can further include following: In step S240, for a target query in the L queries, an actually returned result of the target query is an updated query result generated by adding to an original query result of the target query a target noise sampled from target noise distribution of differential privacy, where the target noise distribution is determined based on the noise power allocated to the target query.

In an implementation, the target noise distribution can be Gaussian noise distribution. Correspondingly, the noise power of the target query is used as a variance of Gaussian distribution and 0 is used as a mean to generate corresponding Gaussian noise distribution. For clear description, in the following, the target query is denoted as the [symbol] ^{th} query and the noise power of the target query is denoted as [symbol] . Therefore, the Gaussian noise distribution corresponding to the target query can be denoted as [symbol] (0, [symbol] ).

Based on the determined Gaussian noise distribution [symbol] (0, [symbol] ), the target noise β can be sampled from the Gaussian noise distribution and added to the original query result [symbol] of the target query, to obtain a corresponding actually returned result. An equation is as follows:

[symbol]

= [symbol] + [symbol] , [symbol] ˜ [symbol] (0, [symbol] ) (19)

Equation (19) is described in detail with reference to examples of the query type.

According to an implementation, if the query type of the target query is a counting query, an actually returned counting query result can be calculated based on the following equation:

[symbol]

=└Count_{c,N}+ [symbol] _{c}┐c=1, . . . C (20)

In the equation (20), N represents the total number of data samples in the target dataset, c represents a c^{th} data category, C represents a total number of data categories, z_{c} represents noise randomly sampled from Gaussian noise distribution corresponding to the counting query, Count_{c,N} represents an original query result of the counting query for the c^{th} category, [symbol] represents an actually returned result obtained after the noise is added, and the operator └ ┐ represents rounding to obtain an integer.

As such, the actually returned result corresponding to the counting query type can be determined. It should be understood that, when an actually returned result corresponding to each query is determined, noise sampling is performed based on corresponding Gaussian noise distribution. For example, for two queries of the same type, random sampling is performed twice based on the same Gaussian noise distribution corresponding to the two queries, and then the sampled noise is separately added to original query results corresponding to the query types, to correspondingly obtain two actually returned results.

According to an implementation, if the query type of the target query is a maximum value query, an actually returned maximum value query result can be calculated based on the following equation:

\tilde{x}ₘₐₓ=x_{(N)}+ [symbol] (21)

In the equation (21), [symbol] represents noise randomly sampled from Gaussian noise distribution corresponding to the maximum value query; x_{(N)} represents an original query result of the maximum value query, i.e., the greatest value in the target dataset; and \tilde{x}ₘₐₓ represents an actually returned result corresponding to the maximum value query.

According to still an implementation, if the query type of the target query is a minimum value query, an actually returned minimum value query result can be calculated based on the following equation:

\tilde{x}ₘᵢₙ=x₍₁₎+ [symbol] (22)

In the equation (22), [symbol] represents noise randomly sampled from Gaussian noise distribution corresponding to the minimum value query; x₍₁₎ represents an original query result of the minimum value query, i.e., a smallest value in the target dataset; and \tilde{x}ₘᵢₙ represents an actually returned result corresponding to the minimum value query.

According to an implementation, if the query type of the target query is a mean value query, an actually returned mean value query result can be calculated based on the following equation:

$${\tilde{x}}_{mean} = \frac{{\sum }_{i = 1}^{N} {x}_{i}}{N} + 𝓏 \qquad ( 23 )$$

In the equation (23), [symbol] represents noise randomly sampled from Gaussian noise distribution corresponding to the mean value query,

$$\frac{{\sum }_{i = 1}^{N} {x}_{i}}{N}$$

represents a mean of the target dataset, and \tilde{x}ₘₑₐₙ Inean represents an actually returned result corresponding to the mean value query.

According to an implementation, if the query type of the target query is a variance query, an actually returned variance query result can be calculated based on the following equation:

\tilde{x}ᵥₐᵣ=Σᵢ₌₁^{N}(xᵢ−μ)² (24)

In the equation (24), [symbol] represents noise sampled from Gaussian noise distribution corresponding to the variance query, Σᵢ₌₁^{N}(xᵢ−μ)² represents a variance of the target dataset, and \tilde{x}ᵥₐᵣ represents an actually returned result corresponding to the variance query.

Sampling and addition of the target noise is described herein by using the Gaussian mechanism of differential privacy as an example. In an implementation, the target noise power is determined based on a Laplace mechanism of differential privacy. Correspondingly, the noise power of the target query can be used as a scale parameter of Laplace distribution and 0 can be used as a location parameter to generate corresponding Laplace noise distribution, to sample and add the target noise to obtain an actually returned result. In an implementation, the target noise can be sampled and added based on an exponential mechanism of differential privacy to obtain an actually returned result.

According to the description herein, an actually returned result corresponding to each target query in the L queries can be determined.

It should be noted that the query processing method disclosed in this implementation of the present specification can be applied to a plurality of implementation scenarios. In a typical scenario, as shown in FIG. 1, a batch of to-be-processed query requests is first received. Then, in step S210, a number L of to-be-processed queries and a query type of each of the to-be-processed queries is determined based on the batch of query requests. In an implementation, a plurality of query requests received in a predetermined time period (for example, in a previous day or in last 10 min) can be obtained, a number of the plurality of query requests is denoted as L, and a query type indicated by each query request is determined. Afterwards, in step S240, the L query requests are respectively used as target queries to correspondingly sample noise and perform noise superposition based on an original query result, to obtain an actually returned result of each query request. As such, differential privacy processing for a batch of query requests can be completed.

In an implementation scenario, for query requests that may be received in the future, a number L of queries that can be performed and a query type of each of the queries can be preconfigured. Therefore, this part of preconfigured information can be directly obtained in step S210. It should be noted that, configuration of the number of queries and the query type can be determined by an employee by analyzing historical query data corresponding to the target dataset.

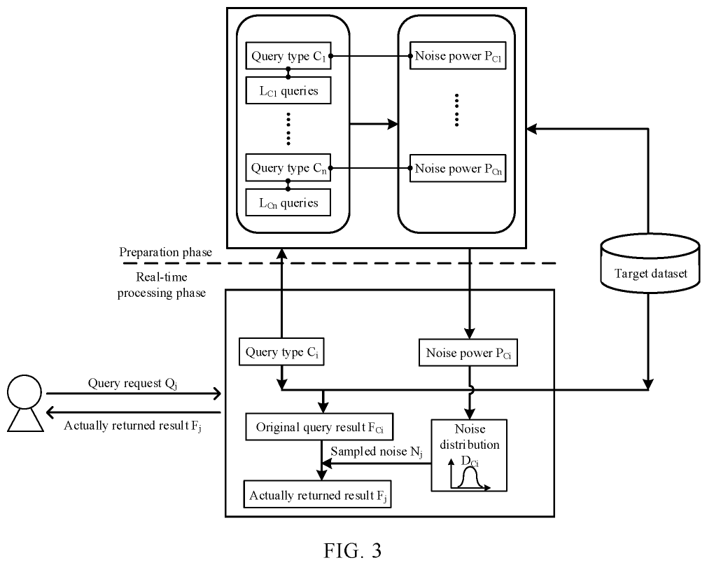

Further, in a detailed implementation scenario, as shown in FIG. 3, in a preparation phase, the above steps S210, S220, and S230 are performed to determine a noise power allocated to each query. Then, in an online processing phase, step S240 is performed based on a received current query request Qⱼ. For example, the current query request Qⱼ is used as the target query, which corresponds to a current query type Cᵢ. When it is determined that a number of processed requests for the target dataset corresponding to the current query type Cᵢ is less than a predetermined number L_{Ci} of queries that can be performed, the current query request Qⱼ is used as the target query. In this case, an original query result Fc, corresponding to the query type Cᵢ is determined based on the target dataset and a noise power P_{Ci} corresponding to the current query type Cᵢ determined in the preparation phase is obtained, and noise Nⱼ sampled from noise distribution determined based on the noise power P_{Ci} is further added to the original query result F_{Ci} to obtain an actually returned result Fⱼ. Alternatively, if it is determined that the number of processed requests is equal to the number L_{Ci} of queries that can be performed, the current query request Qⱼ is discarded.

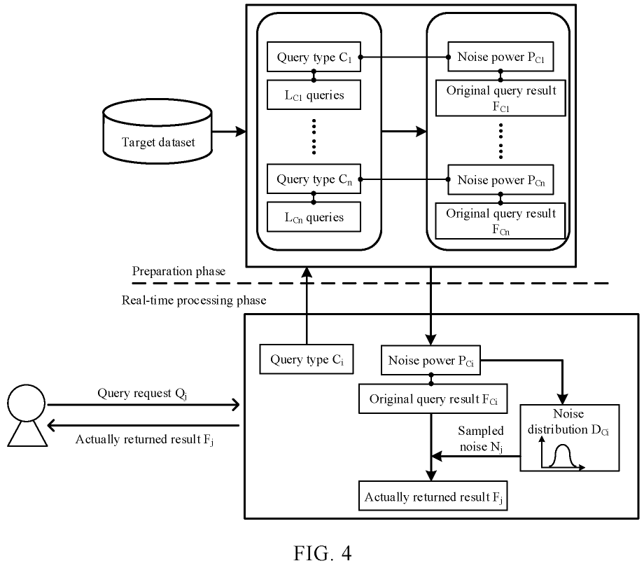

In an implementation scenario, as shown in FIG. 4, in a preparation phase, the above steps S210, S220, and S230 are performed to determine a noise power allocated to each query, and further determine an original query result corresponding to each query type of the query types based on the target dataset. Then, in an online processing phase, step S240 is performed based on a received current query request Qⱼ. For example, the current query request Qⱼ is used as the target query, which corresponds to a current query type Cᵢ. When it is determined that a number of processed requests for the target dataset corresponding to this type is less than a predetermined number L_{Ci} of queries that can be performed, the current query request Qⱼ is used as the target query. In this case, an original query result F_{Ci} and a noise power P_{Ci} corresponding to the current query type Cᵢ determined in the preparation phase are obtained, and noise Nⱼ sampled from noise distribution determined based on the noise power P_{Ci} is further added to the original query result F_{Ci} to obtain an actually returned result Fⱼ. Otherwise, the current query request Qⱼ is discarded.

In an implementation scenario, as shown in FIG. 5, in a preparation phase, step S210 to step S240 are performed to obtain an actually returned result corresponding to each of the L queries. Afterwards, in an online processing phase, a current query request Qᵢ is received, which corresponds to a current query type Cᵢ. When it is determined that a number of processed requests for the target dataset corresponding to this type is less than a predetermined number of queries that can be performed, an actually returned result that corresponds to the current query type Cᵢ and that is not yet used is obtained from L actually returned results determined in the preparation phase and is used as an actually returned result Rᵢ of the current query request Qᵢ. Otherwise, the current query request Qᵢ is discarded.

Implementation scenarios of the query processing method disclosed in the implementations of the present specification are described above.

In conclusion, the query processing method for data privacy protection disclosed in the implementations of the present specification can be used to allocate, to each query in a batch of queries, a suitable noise power that balances data privacy protection and accuracy of query result. For example, a lowest possible noise power, which still can prevent data privacy from being leaked is allocated to a query to maximize accuracy of a query result.

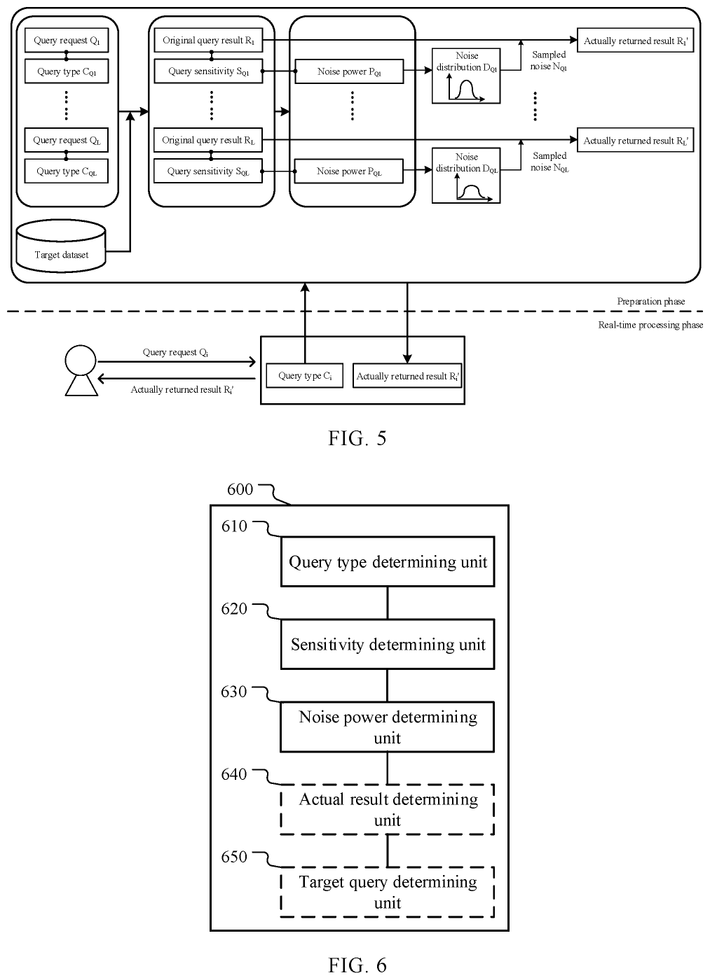

Corresponding to the above query processing method, the implementations of the present specification further disclose a query processing apparatus. FIG. 6 is a schematic diagram illustrating a structure of a query processing apparatus according to an implementation. The apparatus can be implemented as any computing unit, platform, server, device cluster that has a computing and processing capability, for example, can be a user terminal or the service platform shown in FIG. 1. As shown in FIG. 6, the apparatus 600 includes the following units:
a query type determining unit 610, configured to determine query types of L queries to be performed on a target dataset, where the target dataset includes data of an object; a sensitivity determining unit 620, configured to determine query sensitivity of each query type of the query types for the target dataset; and a noise power determining unit 630, configured to determine, based on the query sensitivity corresponding to each query and a privacy budget parameter predetermined for a total set of the L queries, a noise power allocated to each query.

In an implementation, the query type determining unit 610 is for example configured to receive L query requests for the target dataset, where each query request indicates a query type of the query request.

In an implementation, the query type determining unit 610 is for example configured to obtain a number L of queries that can be performed that is preconfigured for the target dataset and a query type of each of the queries.

In an implementation, the query type is any one of following: a counting query, a maximum value query, a minimum value query, a mean value query, or a variance query.

In an implementation, the object is any one of following: a user, a commodity, or a business event.

In an implementation, the business event is any one of following: registration, access, login, or payment.

In an implementation, the object is a user, and the data of the business event is any one of following: age, gender, income, interests and hobbies, physiological indicators, or operation indicators.

In an implementation, the sensitivity determining unit 620 is, for example, configured to: for each query type of the query types, obtain the query sensitivity corresponding to the query type based on a greatest absolute difference between a first result and a second result, where the first result is a result obtained by performing the type of query on the target dataset, and the second result is a result obtained by performing the type of query on an adjacent dataset of the target dataset.

In an implementation, the query type includes a counting query, and the sensitivity determining unit 620 is, for example, configured to determine the query sensitivity of the counting query to be a value of 1.

In an implementation, the query types include a maximum value query or a minimum value query, and the sensitivity determining unit 620 is, for example, configured to: determine a greatest value and a smallest value in the target dataset; and determine a result of subtracting the smallest value from the greatest value as the query sensitivity of the maximum value query or the minimum value query.

In an implementation, the query types include a mean value query, and the sensitivity determining unit 620 is, for example, configured to: determine a greatest value in the target dataset; and determine a ratio between an absolute value of the greatest value and an amount of data in the target dataset plus 1 as the query sensitivity of the mean value query.

In an implementation, the query types include a variance query, and the sensitivity determining unit 620 is, for example, configured to: determine a greatest value and a smallest value in the target dataset; and determine a product of following factors as the query sensitivity of the variance query: a square of a difference between the greatest value and the smallest value, an amount of data in the target dataset, and a reciprocal of a result obtained after a square operation is performed on the amount of data plus 1.

In an implementation, the noise power determining unit 630 is, for example, configured to: determine a sum of the query sensitivity of the L queries based on the query sensitivity of each query; and for any query, determine, based on the query sensitivity of the query, the sum of the query sensitivity, and the privacy budget parameter, the noise power allocated to the query.

In an example implementation, the noise power determining unit 630 is further configured to: obtain a variable value of a mean variable, where the variable value is determined based on a parameter value of the privacy budget parameter and a constraint relationship between the privacy budget parameter and the mean variable in a Gaussian mechanism of differential privacy; and determine a product of following factors as the noise power of the query: the query sensitivity of the query, the sum of the query sensitivity, and a reciprocal of a result obtained after a square operation is performed on the variable value.

In an implementation, the privacy budget parameter includes a budget parameter and a relaxation parameter.

In an implementation, the apparatus 600 further includes an actual result determining unit 640, configured to: for a target query in the L queries, determine an actually returned result of the target query as an original query result of the target query added with a target noise sampled from target noise distribution of differential privacy, where the target noise distribution is determined based on the noise power allocated to the target query.

In an example implementation, the target noise distribution is Gaussian noise distribution, and the Gaussian noise distribution uses the noise power of the target query as a variance and uses 0 as a mean.

In an aspect, in an example implementation, the apparatus further includes a target query determining unit 650, configured to: receive a current query request for the target dataset, where the current query request corresponds to a current query type; determine whether a number of processed requests corresponding to the current query type is less than a predetermined threshold, where query requests corresponding to the number of processed requests are directed to the target dataset; and use the current query request as the target query in response to determining that the number of processed requests is less than the predetermined threshold.

According to an implementation of an aspect, a computer-readable storage medium is further provided. The computer-readable storage medium stores a computer program, and when the computer program is executed in a computer, the computer is enabled to perform the method described with reference to FIG. 2.

According to an implementation of an aspect, a computing device is further provided, including a memory and a processor. The memory stores executable code, and when executing the executable code, the processor implements the method described with reference to FIG. 2.

A person skilled in the art should be aware that, in the above one or more examples, the functions described in the present invention can be implemented by hardware, software, firmware, or any combination thereof. When the functions are implemented by software, the functions can be stored in a computer-readable medium or transmitted as one or more instructions or code in the computer-readable medium.

The characteristics, technical solutions, and beneficial effects of the present invention are further described in detail in the above example implementations. It should be understood that the above descriptions are merely example implementations of the present invention, but are not intended to limit the protection scope of the present invention. Any modification, equivalent replacement, or improvement made based on the technical solutions in the present invention shall fall within the protection scope of the present invention.

What is claimed is:

1. A method, comprising:
determining query types of L queries to be performed on a target dataset;
determining query sensitivity of each query type of the query types for the target dataset;
determining, based on query sensitivity corresponding to each query of the L queries and a privacy budget parameter determined for a total set of the L queries, a noise power allocated to each query of the L queries, respectively; and
applying the noise power to each query of the L queries when the query is performed on the target dataset.

2. The method according to claim 1, wherein the determining the query types of the L queries to be performed on the target dataset includes:
receiving L query requests for the target dataset, wherein each query request indicates a query type of the query request.

3. The method according to claim 1, wherein the determining the query types of the L queries to be performed on the target dataset includes:
obtaining a preconfigured number of queries performable on the target dataset and a query type of each of the preconfigured number of queries.

4. The method according to claim 1, wherein a query type of the query types is one of: a counting query, a maximum value query, a minimum value query, a mean value query, or a variance query.

5. The method according to claim 1, wherein the object is one or more of: a user, a commodity, or a business event.

6. The method according to claim 5, wherein the business event is one or more of: registration, access, login, or payment.

7. The method according to claim 1, wherein the object is a user, and the data of the object is one or more of: age, gender, income, interests and hobbies, physiological indicators, or operation indicators.

8. The method according to claim 1, wherein the determining the query sensitivity of each query type of the query types for the target dataset includes:
for each query type of the query types, obtaining the query sensitivity corresponding to the query type based on a greatest absolute difference between a first result and a second result, wherein the first result is a result obtained by performing the type of query on the target dataset, and the second result is a result obtained by performing the type of query on an adjacent dataset of the target dataset.

9. The method according to claim 1 , wherein the query types include a counting query, and the determining the query sensitivity of each query type of the query types for the target dataset includes:
determining the query sensitivity of the counting query to be a value of 1.

10. The method according to claim 1, wherein the query types include a maximum value query or a minimum value query, and the determining the query sensitivity of each query type of the query types for the target dataset includes:
determining a greatest value and a smallest value in the target dataset; and
determining a result of subtracting the smallest value from the greatest value as the query sensitivity of the maximum value query or the minimum value query.

11. The method according to claim 1, wherein the query types include a mean value query, and the determining the query sensitivity of each query type of the query types for the target dataset includes:
determining a greatest value in the target dataset; and
determining a ratio between an absolute value of the greatest value and an amount of data in the target dataset plus 1 as the query sensitivity of the mean value query.

12. The method according to claim 1, wherein the query types include a variance query, and the determining the query sensitivity of each query type of the query types for the target dataset includes:
determining a greatest value and a smallest value in the target dataset; and
determining a product of following factors as the query sensitivity of the variance query: a square of a difference between the greatest value and the smallest value, an amount of data in the target dataset, and a reciprocal of a result obtained after a square operation is performed on the amount of data plus 1.

13. The method according to claim 1, wherein the determining, based on the query sensitivity corresponding to each query of the L queries and the privacy budget parameter determined for the total set of the L queries, the noise power allocated to each query of the L queries, respectively, includes:
determining a sum of query sensitivity of the L queries based on the query sensitivity of each query; and
for a query, determining the noise power allocated to the query based on the query sensitivity of the query, the sum of the query sensitivity, and the privacy budget parameter.

14. The method according to claim 13, wherein the determining the noise power allocated to the query based on the query sensitivity of the query, the sum of the query sensitivity, and the privacy budget parameter includes:
obtaining a variable value of a mean variable, wherein the variable value is determined based on a parameter value of the privacy budget parameter and a constraint relationship between the privacy budget parameter and the mean variable in a Gaussian mechanism of differential privacy; and
determining a product of following factors as the noise power of the query: the query sensitivity of the query, the sum of the query sensitivity, and a reciprocal of a result obtained after a square operation is performed on the variable value.

15. The method according to claim 14, wherein the privacy budget parameter includes a budget parameter and a relaxation parameter.

16. The method according to claim 1, wherein the applying the noise power to each query of the L queries includes
for a target query in the L queries, determining an updated result of the target query by adding to an original query result of the target query a target noise sampled from target noise distribution of differential privacy, wherein the target noise distribution is determined based on a noise power allocated to the target query.

17. The method according to claim 16, wherein the target noise distribution is Gaussian noise distribution, and the Gaussian noise distribution uses the noise power of the target query as a variance and uses 0 as a mean.

18. The method according to claim 16, further comprising:
receiving a current query request for the target dataset, wherein the current query request corresponds to a current query type;
determining whether a number of processed requests corresponding to the current query type is less than a determined threshold, wherein query requests corresponding to the number of processed requests are directed to the target dataset; and
using the current query request as the target query in response to determining that the number of processed requests is less than the predetermined threshold.

19. A computer system having one or more processors and one or more storage devices, the one or more storage devices, individually or collectively, having computer executable instructions stored thereon, the computer executable instructions, when executed by the one or more processors, enabling the one or more processors to, individually or collectively, implement acts comprising:
determining query types of L queries to be performed on a target dataset;
determining query sensitivity of each query type of the query types for the target dataset;
determining, based on query sensitivity corresponding to each query of the L queries and a privacy budget parameter determined for a total set of the L queries, a noise power allocated to each query of the L queries, respectively; and
applying the noise power to each query of the L queries when the query is performed on the target dataset.

20. A non-transitory storage medium having computer executable instructions stored thereon, the computer executable instructions, when executed by one or more processors, enabling the one or more processors to, individually or collectively, implement acts comprising:
determining query types of L queries to be performed on a target dataset;
determining query sensitivity of each query type of the query types for the target dataset;
determining, based on query sensitivity corresponding to each query of the L queries and a privacy budget parameter determined for a total set of the L queries, a noise power allocated to each query of the L queries, respectively; and
applying the noise power to each query of the L queries when the query is performed on the target dataset.
